(19) United States
(12) Patent Application Publication
(10) Pub. No.: US 2012/0180120 A1
(43) Pub. Date: Jul. 12, 2012

(54) SYSTEM FOR DATA LEAK PREVENTION FROM NETWORKS USING CONTEXT SENSITIVE FIREWALL

(76) Inventor: Sonit Basantkumar Jain, Mumbai (IN)

(21) Appl. No.: 13/093,281

(22) Filed: Apr. 25, 2011

(30) Foreign Application Priority Data
Jan. 12, 2011 (IN) 110/MUM/2011

(51) Int. Cl. G06F 21/00

(52) U.S. Cl. 726/11

(57) ABSTRACT

Method and system of preventing data leak in a network that allows for context based access of network resources by network users is provided. Where the communication network can be an open network like the internet or a closed network like a company's Local Area Network (LAN). The network resource may be any application, website, program, communication means etc. available by accessing the network. A request is sent to a network firewall to access a web application, where the web application is identified. A context template is created for the web application, and compared with the request to create a request context map. The request context map is compared to a request context rule on the network firewall. Access is provided to the web application when the request context map matches the request context rule.

### CROSS-REFERENCE TO RELATED APPLICATION

The present application claims priority under 35 U.S.C. 119(a) to Indian (IN) patent application number 110/MUM/2011 filed Jan. 12, 2011, which IN patent application is incorporated herein by reference in its entirety.

### BACKGROUND OF THE INVENTION

1. Field of the Invention

The present invention relates to the field of computer networks. In particular, the present invention relates to a method for providing network security.

2. Description of the Prior Art

In the fast paced communication age of today, almost all information and data transfer happens on communication networks. A communication network can be a public network, such as the Internet, in which data packets are passed between users over untrusted, i.e., non-secure communication links. Alternatively, various organizations, typically corporations, use what is known as an intranet communications network, accessible only by the organization's members, employees, or others having access authorization. Intranets typically connect one or more private servers, such as a local area network (LAN). The network configuration in a preferred embodiment of this invention can include a combination of public and private networks. For example, two or more LANs can be coupled together with individual terminals using a public network, such as the Internet. A network point that acts as an entrance to another network is known in the art as a gateway.

Conventional communication systems that include links between public and private networks typically include means to safeguard the private networks against intrusions through the gateway provided at the interface of the private and public networks. The means designed to prevent unauthorized access to or from a private are commonly known as firewalls or proxy server, which can be implemented in both hardware and software, or a combination of both. Thus, a firewall is a device that can be coupled in-line between a public network and a private network for screening packets received from the public network.

Many conventional firewalls that monitor and restrict network activity rely on network wide policy making to prevent high risk activities among the network users. The policy can apply to entire commercial establishment spread across several locations, a single location, or a group of network users. These conventional systems are also capable of preventing or allowing a single user on the network to access certain resources on the communication network. The policies do not take into consideration the context for network resource access and can be overly restrictive.

Conventional network security systems impose very strict network and communication network resource management policies that cannot be bypassed until an administrator grants special access. Such systems can be an impediment to regular communications and lead to delays in communication and subsequent business losses.

Conventional network security systems do not allow for users to access communication resources even when the context for accessing the communication resource is business critical. Policy setting and resource access in conventional network security system is not configured as per the context of use. These network security systems treat all resource usage requests by users the same way irrespective of the context of the request for resource use.

There exists a need for an intelligent network security system that can allow network users to access network resources based on the context of use. There also exists a need for methods of network security policy making that allows for user and context level control of network resources to prevent data leak from the network. In this regard, the present invention substantially fulfills this need. In this respect, the system for data leak prevention from networks using context sensitive firewall according to the present invention substantially departs from the conventional concepts and designs of the prior art, and in doing so provides an apparatus primarily developed for the purpose of network security.

### SUMMARY OF THE INVENTION

In view of the foregoing disadvantages inherent in the known types of network security systems now present in the prior art, the present invention provides an improved system for data leak prevention from networks using context sensitive firewall, and overcomes the above-mentioned disadvantages and drawbacks of the prior art. As such, the general purpose of the present invention, which will be described subsequently in greater detail, is to provide a new and improved system for data leak prevention which has all the advantages of the prior art mentioned heretofore and many novel features that result in a network security system which is not anticipated, rendered obvious, suggested, or even implied by the prior art, either alone or in any combination thereof.

The present invention provides methods for overcoming some of the difficulties presented in the Background of the Invention.

In brief, a method of preventing data leaks in a network that allows for context based access of network resources by network users is provided. Where the communication network can be an open network like the internet or a closed network like a company's Local Area Network (LAN). The network resource may be any application, website, program, communication means etc. available by accessing the network.

In accordance with a further aspect of the invention a method of preventing data leak in a network may include sending a request to a network firewall to access a web application, identifying the web application, creating a context template for the web application, comparing the request with the context template to create a request context map, comparing the request context map to a request context rule on the network firewall, and sending the request to the web application when the request context map matches the request context rule.

In accordance with another aspect of the invention a system for preventing data leak in a network is provided. The system may include a network for sending a request to a network firewall, a web application for receiving the request, a firewall comprising, a processor, a storage device for storing a context template, and a means for identifying the web request sent from the network, generating a context template to store in the storage device comparing the web request to a context template stored in the storage device, and sending the web request to the web application.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

The details of one or more implementations are set forth in the accompanying drawings and the description below. Other features will be apparent from the description and drawings, and from the claims.

### BRIEF DESCRIPTION OF DRAWINGS

The invention will be better understood and objects other than those set forth above will become apparent when consideration is given to the following detailed description thereof. Such description makes reference to the annexed drawings wherein

FIG. 1 is a block diagram of a network system for preventing data leak in a network.

FIG. 2 is a flow diagram of a process for preventing data leak in a network.

Like reference symbols in the various drawings indicate like elements.

### DETAILED DESCRIPTION

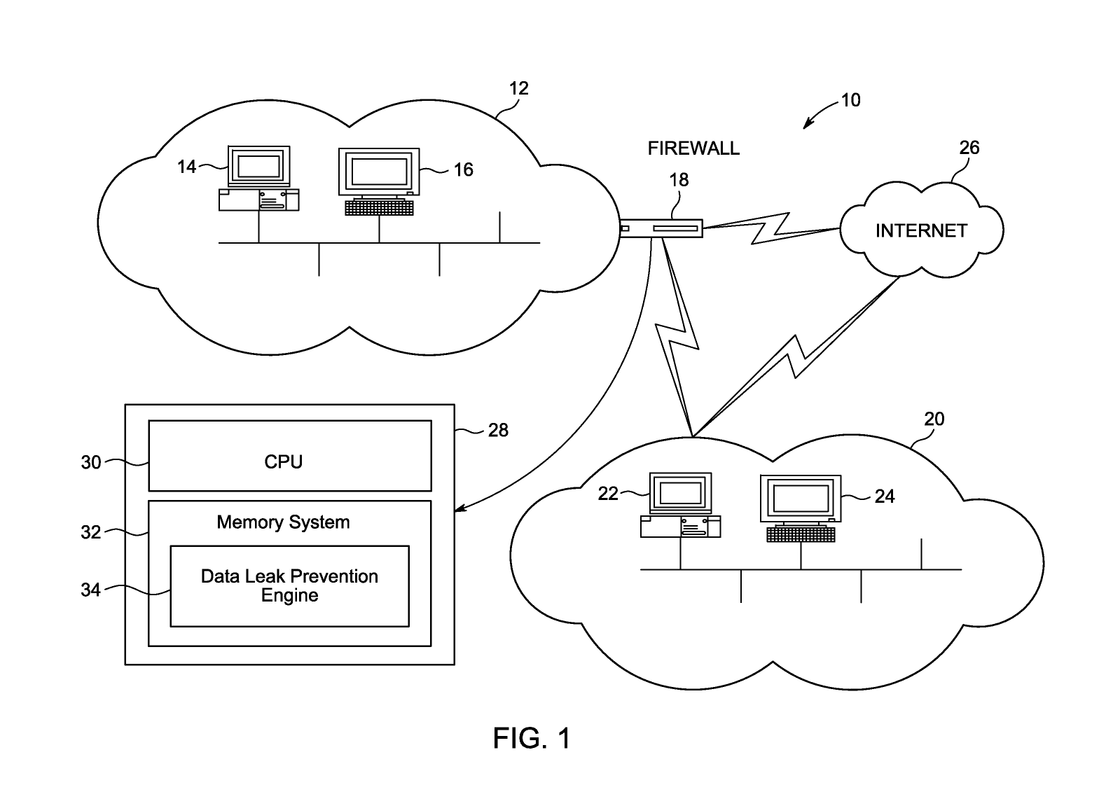

FIG. 1 is a block diagram of a network system 10 for preventing data leak in a network. Network system 10 includes a first network 12 with multiple network devices (14, 16), two of which are illustrated, and a firewall 18. First network 12 is connected to a second network 20, with multiple network devices (22, 24), two of which are illustrated, through firewall 18. First network 12 can be directly connected to second network 20 through firewall 18. First network 12 can also be connected to a second network 20 through firewall 18 via third network 26 (e.g., the Internet).

However, other network devices, network types and network components can also be used and the present invention is not limited to the network devices, network types and network components described. In addition, although illustrated with four network devices, and one firewall, network system 10 typically includes tens to thousands of network devices in networks (12, 20) and may also include multiple firewalls.

An operating environment for network devices and firewalls of a preferred embodiment the present invention include a processing system 28 with at least one high speed Central Processing Unit 30 (“CPU”) and a memory system 32. In accordance with the practices of persons skilled in the art of computer programming, the present invention is described below with reference to acts and symbolic representations of operations that are performed by the processing system 28, unless indicated otherwise. Such acts and operations are referred to as being “computer-executed” or “CPU executed.” Although described with one CPU 30, alternatively multiple CPUs may be used for a preferred embodiment of the present invention.

The memory system 32 may include main memory and secondary storage. The main memory is high-speed random access memory (“RAM”). Main memory can include any additional or alternative high-speed memory device or memory circuitry. Secondary storage takes the form of long term storage, such as Read Only Memory (“ROM”), optical or magnetic disks, organic memory or any other volatile or non-volatile mass storage system. Those skilled in the art will recognize that the memory system can comprise a variety and/or combination of alternative components.

It will be appreciated that the acts and symbolically represented operations include the manipulation of electrical signals by the CPU. The electrical signals cause transformation of data bits. The maintenance of data bits at memory locations in a memory system thereby reconfigures or otherwise alters the CPU's operation. The memory locations where data bits are maintained are physical locations that have particular electrical, magnetic, optical, or organic properties corresponding to the data bits.

The data bits may also be maintained on a computer readable medium including magnetic disks, optical disks, organic disks and any other volatile or non-volatile mass storage system readable by the CPU. The computer readable medium includes cooperating or interconnected computer readable medium, which exist exclusively on the processing system or may be distributed among multiple interconnected processing systems that may be local or remote to the processing system.

In accordance with aspects of the invention, a first network device (e.g., first network device 14) on first network 12 inside firewall 18 requests for access to a web application via a network 26 (e.g., the Internet) outside firewall 18. The request may be for data transfer (e.g., file transfer or e-mail retrieval), for viewing a web page, for sending messages on the web pages, for accessing multimedia on web pages (audio or video), instant messaging, Web Chats, database access, social networking applications, applications used to share file, etc.

The firewall 18 transfers the request to a data leak prevention engine 34 stored on a memory device. The data leak prevention engine 34 compares the request for accessing web application by comparing a context template for the web application stored on memory device 32. The context template for the web application may be predefined or may be generated when the web application is identified. The data leak prevention engine 34 compares the request with the context template by breaking down the request. The compared request and context template are together matched with rule defined for network 12 in firewall 18. If the request and context template matches the rule defined for network device 14 in firewall 18, the request to access the web application is allowed.

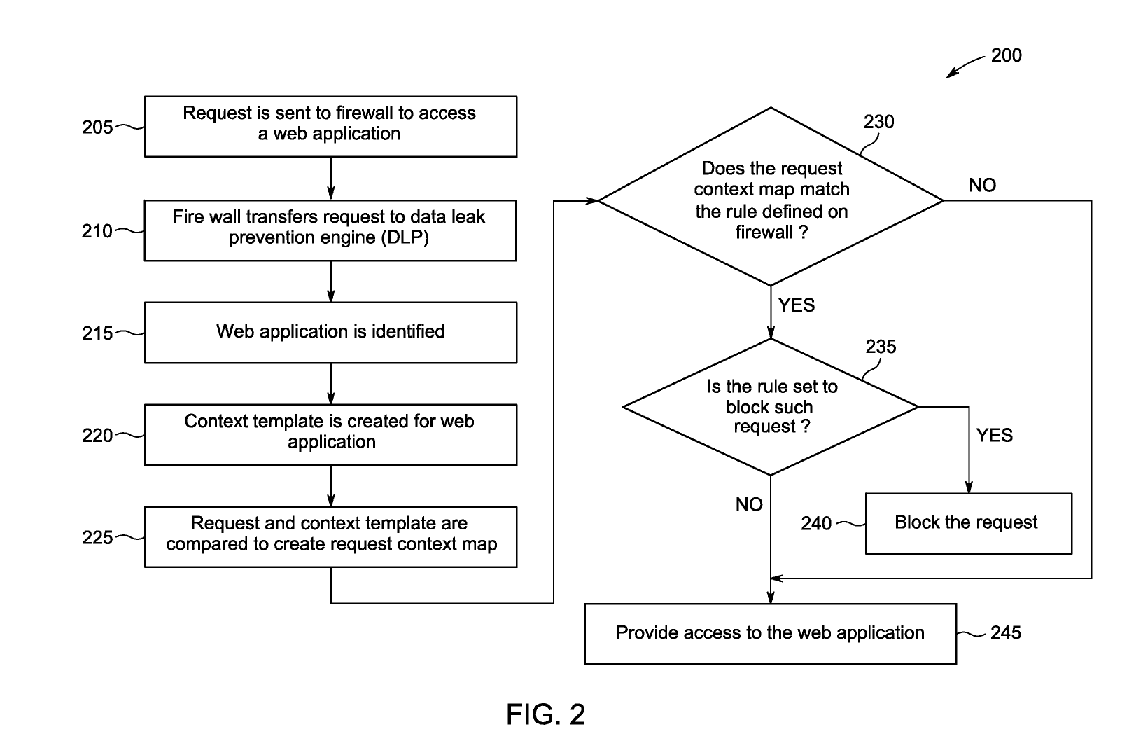

FIG. 2 is a flow diagram of a process 200 for preventing data leak in a network. Initially, a user request to access a web application is sent to the firewall (step 205). The user request may be to send data to the web application or receive data from the web application. The request may be for data transfer (e.g., file transfer or e-mail retrieval or sent), for viewing a web page, for sending messages on the web pages, for accessing multimedia on web pages (audio or video), instant messaging, Web Chats, database access, social networking applications, applications used to share file, etc. The web application may be a web page at a URL, a file at a remote server, online documents, online email service, a social networking site etc.

The firewall routes the request to a Data Leak Prevention Engine (step 210). The data leak prevention engine may be a software program installed on a memory device accessible to the firewall. Data Leak Prevention Engine may be a embedded software on the firewall, may be a series of computer programs running on a computer accessible to the firewall, may be a series of computer programs programmed on a hardware chip, a set of program on a firewall/proxy or network device or on a separate box connected to the firewall or proxy server using network protocols.

The Data Leak Prevention Engine identifies the web application to which the access request is made (step 215). The web application may be identified by the URL visited which may also includes the parameter sent with the URL. The web application may be identified by the content type of the request, the method of the request, the protocol used by the request, header information which would also include, but not limiting to, cookies, Content-Length etc., data sent or received from the application. The web application may also be identifies by multiple HTTP requests instead of just a single request.

Once the web application is determined, a context template is created for that application (step 220). The context template may be created using pre-defined templates. The context template may be set of instructions to break down the data sent to map the application content i.e. provides meaning to raw data based on the application used.

After the context template is created the request is compared with the context template to create a request context map. The request is compared to the template by breaking down the request into various parameters. The request which is sent may be broken down to identify into key-value structure sent and received. The raw data is broken down to key-value for e.g. (From address/value, To address/value), template may determine the meaning of value by the position of the data stored. Data can also be given meaning based on multiple transactions. The template identifies these transactions and gives meaning to the data. The request may be broken down in the structure based on the position of the data sent in one or multiple request sessions. The request may be broken down by reference of data sent across multiple sessions determined by the template. Along with the application context, information like the user who is using the application, the time or day of using the application, the IP address from where the application is used may also be utilized to generate the request context map.

The request context map is matched with the rules defined in the firewall for similar request context maps (step 230). If the rule is to block such requests the request is blocked (240), error message may also be shown to the user who initiated the web application access request. If the rule is to allow such requests then the firewall allows access to the web application (step 245). The system can also alert the administrator.

To understand the working of the method an illustrative example is given below.

A user requests accesses to a web application. The request is sent to a firewall (step 205). The firewall transfers the request to a Data Leak Prevention engine (step 210). For the purpose of this example the request is to send a file attachment via Gmail from the email address user@gmail.com. The user uses a web front-end to upload a file, which he would eventually attach to the mail. The data leak prevention engine stores this file. The data leak prevention engine creates a context template for this request. An example of the context map is given below.

URL

User name

Email id

Other parameters (Can also be determined using multiple transactions)

The comparison to the context template is done by breaking the request down to parameters to create a request context map (step 225) as listed below,

URL: www.gmail.com

User name: user

Email id: user@gmail.com

Other parameter: file attachment.

Once the request context map is created it is matched with the rule defined on the firewall for such requests (step 230). For the purpose of this example the rule for sending attachments via Gmail is to allow only xyz@gmail.com to upload information from the network and send it to the internet. And the rule for sending emails via Gmail without attachment is to allow both user@gmail.com and xyz@gmail.com.

Matching the firewall rule with the request it is evident that the email id user@gmail.com cannot be used for sending attachments outside the network. Hence the request is denied (step 240). In case the user was not sending an attachment the email would have been allowed as the email id user@gmail.com is allowed access, but is denied access only for attachments.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements and different component types may be used in the block diagrams.

The claims should not be read as limited to the described order or elements unless stated to that effect. Therefore, all embodiments that come within the scope and spirit of the following claims and equivalents thereto are claimed as the invention.

What is claimed as being new and desired to be protected by Letters Patent of the United States is as follows:

1. A method for preventing data leak from a network, the method comprising the steps of:
sending a request to a network firewall to access a web application;
identifying the web application;
creating a context template for the web application;
comparing the request with the context template to create a request context map;
comparing the request context map to a request context rule on the network firewall; and
providing access to the web application when the request context map matches the request context rule.

2. The method of claim 1, wherein the web application is a URL which also includes a_parameter sent with the URL.

3. The method of claim 1, wherein the request is for sending data to the web application.

4. The method of claim 1, wherein the request is for receiving data from the web application.

5. The method of claim 1, wherein the request context map is a key-value structure of the request.

6. The method of claim 5, wherein the key-value structure is based on a position of data sent in one or multiple sessions.

7. A system for preventing data leak from a network, the system comprising:
a network for sending a request;
a web application for receiving the request;
a firewall comprising;
a processor;
a storage device for storing a context template; and
a means for identifying the web request sent from the network, generating a context template to store in the storage device comparing the web request to a context template stored in the storage device, and sending the web request to the web application.

8. The system of claim 7, wherein the means is a computer program operable to identify the web request sent from the network, generate a context template to store in the storage device, compare the web request to a context template stored in the storage device, and send the web request to the web application.

9. The system of claim 7, wherein the request is for sending data to the web application.

10. The system of claim 7, wherein the request is for receiving data from the web application.

11. A computer implemented process for preventing data leak from a network, the computer implemented process comprising:
sending a request from at least one network device to a network firewall to access a web application;
using the network firewall to transfer the request to a data leak prevention engine stored on a memory device;
identifying the web application;
creating a context template for the web application, and storing the context template on the memory device;
comparing the request with the context template to create a request context map;
comparing the request context map to a request context rule on the network firewall; and
providing access to the web application when the request context map matches the request context rule.

12. The method of claim 11, wherein the web application is a URL which also includes a parameter sent with the URL.

13. The method of claim 11, wherein the request is for sending data to the web application.

14. The method of claim 11, wherein the request is for receiving data from the web application.

15. The method of claim 11, wherein the request context map is a key-value structure of the request.

16. The method of claim 15, wherein the key-value structure is based on a position of data sent in one or multiple sessions.
